(19) United States
(12) Patent Application Publication
(10) Pub. No.: US 2009/0191459 A1
(43) Pub. Date: Jul. 30, 2009

(54) Electrode for nonaqueous electrolyte secondary battery

(75) Inventors: Yoshiki Sakaguchi, Saitama (JP); Kiyotaka Yasuda, Saitama (JP)

Correspondence Address: YOUNG & THOMPSON, 209 Madison Street, Suite 500, ALEXANDRIA, VA, 22314, US

(73) Assignee: Misui Mining & Smelting Co., Ltd., Tokyo (JP)

(21) Appl. No.: 10/585,336

(22) PCT Filed: Nov. 9, 2004
(86) PCT No.: PCT/JP04/16581

§ 371 Date: Jul. 6, 2006

(30) Foreign Application Priority Data
Jan. 7, 2004 (JP) 2004-002411
Nov. 2, 2004 (JP) 2004-319789

(51) Int. Cl. H01M 4/02; H01M 4/58; C25D 7/00

(52) U.S. Cl. 429/209; 429/231.95; 205/50

(57) ABSTRACT

An electrode (10) characterized by an output terminal (9) being led out from the surface of a part where an active substance layer (3) exists when viewed from the thickness direction of the electrode. Active substance contained in the active substance layer (3) preferably comprises a material having a low electron conductivity. The electrode (10) preferably comprises a pair of current collecting surface layers (4) having a surface touching electrolyte, and at least one active substance layer (3) containing particles (2) of an active substance having a high lithium compound forming power and interposed between the surface layers (4). In the active substance layer (3), a metal material having a low lithium compound forming power permeates between the particles of active substance and the opposite sides are conducting electrically. The entire electrode preferably has a current collecting function as a whole.

### TECHNICAL FIELD

This invention relates to an electrode for nonaqueous electrolyte secondary batteries such as lithium ion secondary batteries and a process of producing the same.

### BACKGROUND ART

In the manufacture of electrodes for lithium ion secondary batteries, it has been a commonly followed practice to, as illustrated in FIG. 7, apply an active material to a surface of a current collector 100 with spacing to make active material-coated regions 101 and uncoated regions 102 and to attach a current collecting tab 103 to each uncoated regions 102 (see, e.g., Patent Document 1).

### Patent Document 1: JP-A-11-354110

### DISCLOSURE OF THE INVENTION

The intermittent application as referred to above makes the electrode production process complicated. The attachment of the current collecting tabs must be controlled accurately to successfully place each tab in each uncoated region, which also makes the process complicated. In addition, the uncoated regions are, in other words, active material-deficient regions, which means a corresponding loss of capacity.

Accordingly, an object of the present invention is to provide an electrode for nonaqueous electrolyte secondary batteries that is free from the above-mentioned various disadvantages of conventional techniques.

The present invention achieves the above object by the provision of an electrode for nonaqueous electrolyte secondary batteries characterized by having an output terminal attached to a surface of the electrode at a position corresponding to a position, in viewing along the thickness direction of the electrode, where an active material layer exists.

The invention also provides a preferred process of producing the electrode. The process for non aqueous electrolyte secondary batteries, comprising the steps of applying an electroconductive slurry containing a particulate active material to a carrier foil to form an active material layer, electroplating the carrier foil having the active material layer by immersing in a plating bath to form a current collecting surface layer on both sides of the active material layer, peeling the carrier foil off one of the current collecting surface layers to provide an electrode, and attaching an output terminal to either of the current collecting surface layers.

The present invention also provides another preferred process of producing the electrode. The process for non aqueous electrolyte secondary batteries, comprising the steps of electroplating one surface of a carrier foil to form a first current collecting surface layer, applying an electroconductive slurry containing a particulate active material to the first surface layer to form an active material layer, electroplating the active material layer to form a second current collecting surface layer on the active material layer, peeling the carrier foil off the first current collecting surface layer to provide an electrode, and attaching an output terminal to either of the first and second current collecting surface layers.

### BRIEF DESCRIPTION OF THE DRAWINGS

FIG. 1 schematically illustrates an enlarged essential part of a first embodiment of the electrode according to the invention.

FIG. 2(a), FIG. 2(b), FIG. 2(c), and FIG. 2(d) each illustrate a step of a preferred process for producing an embodiment of a negative electrode according to the invention.

FIG. 3(a), FIG. 3(b), FIG. 3(c), FIG. 3(d), FIG. 3(e), and FIG. 3(f) each illustrate a step of another process for producing the electrode shown in FIG. 1.

FIG. 4 schematically illustrates a surface layer and micropores being formed therethrough.

FIG. 5 schematically illustrates an enlarged essential part of a second embodiment of the electrode according to the invention.

FIG. 6 is an electron micrograph revealing the cross-sectional structure of the negative electrode obtained in Example 1.

FIG. 7 schematically illustrates the structure of a conventional electrode.

### THE BEST MODE FOR CARRYING OUT THE INVENTION

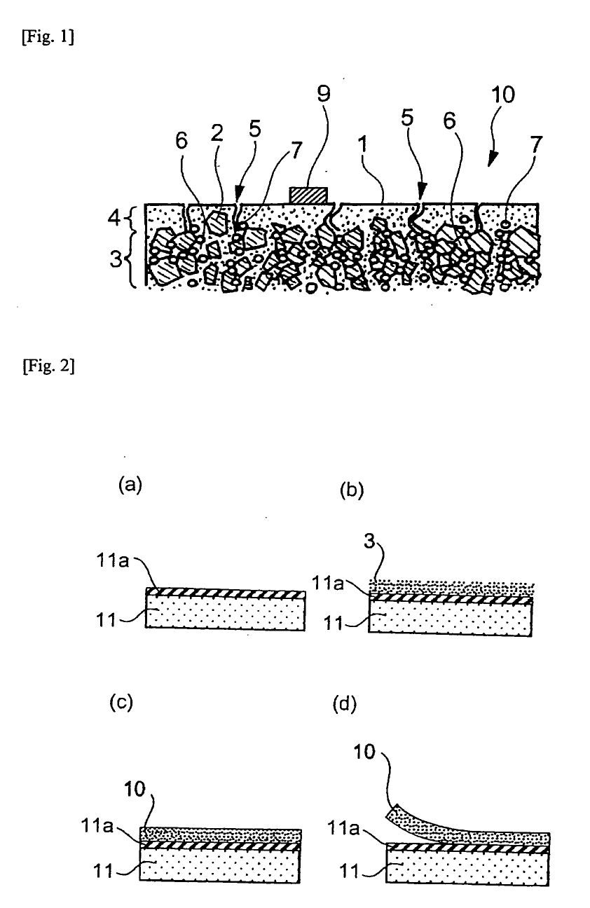

The present invention will be described based on its preferred embodiments with reference to the accompanying drawings. These embodiments represent application of the present invention to a negative electrode of nonaqueous electrolyte secondary batteries. FIG. 1 schematically illustrates an enlarged essential part of a first embodiment of the invention. While only one side of the negative electrode is illustrated, the other side has almost the same structure as shown in FIG. 1.

The negative electrode of the first embodiment has a first surface 1 (shown) and a second surface (not shown). The negative electrode 10 has, between the two surfaces, an active material layer 3 containing a particulate active material 2 having high capability of forming a lithium compound. Each side of the active material layer 3 is continuously covered with a current collecting surface layer 4 (only one of the surface layers 4 is shown). The surface layers 4 on both sides are inclusive of the first surface 1 and the second surface, respectively. As is understood from FIG. 1, the negative electrode 10 does not have such a thick conductor for current collection, called a current collector, e.g., metal foil or expanded metal, as has been used in conventional negative electrodes.

The surface layers 4 are adapted to be brought into contact with a nonaqueous electrolyte when the negative electrode 10 is assembled into a battery. In contrast, a thick, current-collecting conductor used in a conventional negative electrode has no surface in contact with an electrolyte when it has an active material layer on its both sides or only one surface in contact with an electrolyte when it has an active material layer on one side thereof. In other words, in the absence of a thick, current-collecting conductor, the surface layers 4, i.e., the outermost layers of the negative electrode participate in the passage of an electrolyte and also bears a current collecting function combined with a function for preventing fall-off of the active material.

As stated above, the surface layers 4 have a current collecting function. They also serve to prevent the active material of the active material layer 3 from falling off due to expansion and contraction accompanying intercalation and deintercalation of lithium. The surface layers 4 are made of a metal that can be a current collector of nonaqueous electrolyte secondary batteries, preferably a metal that can be a current collector of lithium ion secondary batteries. Such metals include metal materials having low capability of forming a lithium compound, such as copper, nickel, iron, cobalt, and alloys thereof. It is particularly convenient to use copper, nickel, and their alloys. Nickel is preferred for giving an increased strength to the negative electrode 10. A nickel-tungsten alloy is especially preferred to form high-strength surface layers 4. The two surface layers 4 may be of the same or different materials. The expression “low capability of forming a lithium compound” as used herein means no capability of forming an intermetallic compound or a solid solution with lithium or, if any, the capability is such that the resulting lithium compound contains only a trace amount of lithium or is very labile.

Since the surface layer 4 performs the current collecting function, the negative electrode 10 of the present embodiment can have an output terminal 9 attached to the surface of the electrode at the position corresponding to the position, in viewing along thickness direction of the negative electrode, where the active material layer 3 is located. Therefore, it is no more necessary to form an active material-deficient part that has been required to afford a place where to attach an output terminal. As a result, the negative electrode 10 of the present embodiment has an increased capacity compared with conventional electrodes. No need to provide an active material-deficient part allows the active material layer 3 to be formed continuously, which brings about simplification of the production process. The place where to attach the output terminal 9 is not limited. The output terminal 9 can be directly attached anywhere on the surface of the negative electrode 10. This also permits simplification of the production process. The structure of the negative electrode 10 according to the present embodiment is particularly advantageous where in using a semiconductive, poorly electron-conductive material, such as a silicone material, as an active material.

In the present embodiment, the negative electrode 10 has the active material layer 3 covered with the surface layers 4 and has the output terminal 9 attached to the surface layer 4. Therefore, the particulate active material 2 is protected from falling off the active material layer 3 against an outer force that is imposed in attaching the output terminal 9 to the surface layer 4. Methods for attaching the output terminal 9 include ultrasonic welding, laser welding, solder welding, and resistance welding.

Each of the surface layers 4 is thinner than a thick conductor used as a current collector in conventional electrodes. Specifically, the thickness of the surface layer 4 is preferably as small as about 0.3 to 10 μm, still preferably about 1 to 5 μm. Substantially continuous coating of the active material layer 3 can be achieved with this minimum thickness of the surface layers 4. Fall-off of the particulate active material 2 can thus be prevented. The surface layers 4 having a small thickness within the recited range are preferably formed by electroplating as described later. The two surface layers 4 may be the same or different in thickness.

As illustrated in FIG. 1, the negative electrode 10 has a large number of micropores 5 open on at least one of the first surface 1 and the second surface and leading to the active material layer 3. The micropores 5 are formed in at least one of the surface layers 4, extending in the thickness direction of the surface layer 4. The micropores 5 allow a nonaqueous electrolyte to sufficiently penetrate into the active material layer 3 and to sufficiently react with the active material particles 2. In a cross-section of the surface layer 4, the micropores 5 have a width of about 0.1 to 100 μm. To secure prevention of fall-off of the active material, the width of the micropores 5 is preferably about 0.1 to 10 μm. The micropores 5 are so fine and yet wide enough to allow penetration of a nonaqueous electrolyte. In particular, a nonaqueous electrolyte, which has a smaller surface tension than an aqueous one, is capable of penetrating through the micropores 5 with a small width. Such micropores 5 are preferably formed while the surface layer 4 is formed by electroplating.

The micropores 5 open on the first surface 1 and/or the second surface have an average open area of about 0.1 to 50 μm², preferably about 0.1 to 20 μm², still preferably about 0.5 to 10 μm, in their plan view under an electron microscope. The average open area in that range assures sufficient penetration of a nonaqueous electrolyte while effectively preventing the particulate active material 2 from falling off. That range also increases the charge/discharge capacity from the initial stage of charge/discharge cycling. To ensure prevention of fall-off of the particulate active material 2, it is preferred that the average open area be 0.1% to 50%, still preferably 0.1% to 20%, of the maximum cross-sectional area of the active material particles 2. The term “maximum cross-sectional area of the active material particles 2” denotes the maximum cross-sectional area of a sphere having a diameter equal to the median diameter (D₅₀) of the particles of the particulate active material 2.

When whichever of the first surface 1 and the second surface satisfies the above average open area range is observed from above under an electron microscope, the ratio of the total open area of the micropores 5 in the microscopic field to the microscopic field area, called an open area ratio, is preferably 0.1% to 20%, still preferably 0.5% to 10%, for the same reasons as for the average open area of the micropores 5. For the same reasons, when the first surface 1 or the second surface satisfying the above average open area range is observed from above under an electron microscope, it is preferred for the surface to have 1 to 20,000, still preferably 10 to 1,000, even still preferably 30 to 500, micropores 5 within every 1 cm square field.

Because the reaction of the negative electrode 10 occurs predominantly in the side facing the counter electrode, it is only necessary for the micropores 5 to be present in at least one of the surface layers 4. Nevertheless, practical batteries often have a separator and a counter electrode on both sides of a negative electrode. Where the negative electrode 10 of the present embodiment is applied to such a battery configuration, it is desirable that both surface layers 4 have the micropores 5. When the negative electrode 10 having the micropores 5 in only one of the surface layers 4 is used, a set of two negative electrodes 10 joined with their poreless surface layers facing to each other is used to obtain the same effects as with the electrode 10 having the micropores 5 in both surface layers 4.

The active material layer 3 interposed between the first surface 1 and the second surface contains particles of the active material 2 having high capability of forming a lithium compound. Such active materials include silicon materials, tin materials, aluminum materials, and germanium materials. Graphite is also useful. Sandwiched in between a pair of the surface layers 4, the active material 2 is effectively protected from falling off due to expansion and contraction associated with charge/discharge cycles. Kept in contact with an electrolyte through the micropores 5, the active material particles 2 are not hindered from participating in the electrode reaction.

It is preferred to use a silicon material or a tin material as an active material. Particles of the silicon material or tin material include (a) particles of single silicon or single tin, (b) mixed particles containing at least silicon or tin and carbon, (c) mixed particles containing silicon or tin and a metal, (d) particles of a compound of silicon or tin and a metal, (e) mixed particles containing particles of a compound of silicon or tin and a metal and metal particles, and (f) single silicon or tin particles coated with a metal. Compared with the particles (a), i.e., particles of single silicon or single tin, use of the particles (b) to (f) is advantageous in that pulverization of the silicon material particles due to intercalation and deintercalation of lithium is suppressed more. Use of the particles (b) to (f) is also advantageous in that poor electroconductivity of silicon, which is semiconductive, can be compensated for.

The maximum particle size of the active material particles 2 is preferably not greater than 50 μm, still preferably 20 μm or smaller. The median particle size (D₅₀) of the active material particles 2 is preferably 0.1 to 8 μm, still preferably 1 to 5 μm. Particles 2 whose maximum size exceeds 50 μm are apt to fall off to shorten the electrode life. While smaller particles are better with no particular lower limit, a technically practical lower limit of the particle size would be about 0.01 μm. The particle size of the particles 2 can be measured by the laser diffraction-scattering method or electron microscopic observation.

A too small proportion of the active material in a negative electrode results in insufficient energy density, and the too large proportion tends to cause fall-off of the active material. With these tendencies taken into consideration, the proportion of the active material in the negative electrode is preferably 5% to 80%, still preferably 10% to 50%, even still preferably 20% to 50%, by weight.

The thickness of the active material layer 3 is adjusted as appropriate to the proportion of the active material in the negative electrode and the particle size of the active material. It is not particularly critical in the present embodiment. In general, the thickness is 1 to 100 μm, preferably 3 to 40 μm. The active material layer 3 is preferably formed by applying an electroconductive slurry containing the particulate active material 2 as described infra.

Taking the electrode's strength and energy density into consideration, the total thickness of the negative electrode 10 inclusive of the surface layers 4 and the active material layer 3 is preferably about 2 to 50 μm, still preferably about 10 to 50 μm.

The active material layer 3 preferably has a metal material having low capability of forming a lithium compound penetrating into the interstices between the particles making up the layer. The metal material preferably penetrates the whole thickness of the active material layer 3 so that the active material particles exist in the metal material. That is, it is preferred that the active material particles be not practically exposed on the surfaces of the negative electrode 10 but buried in the surface layers 4. Thus, the active material layer 3 exhibits firmer adhesion to the surface layers 4, and the active material is more effectively prevented from falling off. Electroconductivity between the surface layer 4 and the active material is secured by the metal material penetrating through the active material layer 3. Generation of electrically isolated active material particles even in the deep portion of the active material layer 3 are thus prevented effectively. As a result, the current collecting function is retained, reduction in function as a negative electrode is suppressed, and the electrode life is prolonged. These effects are advantageous especially in using a semiconductive, poorly electroconductive material, such as a silicon material, as an active material.

The metal material having low capability of forming a lithium compound and penetrating the active material layer 3 can be selected from those useful to make up the surface layers 4. The metal material may be the same or different from the material making the surface layers 4. For example, (a) all the materials constituting the two surface layers 4 and the metal material penetrating the active material layer 3 may be the same. In this case, the hereinafter described process for fabricating the electrode 10 is carried out through simpler procedures. (b) The material of at least one of the surface layers 4 may be different from the metal material penetrating the active material layer 3. (c) The material(s) constituting the two surface layers 4 may be different from the metal material penetrating the active material layer 3.

In case (c), the surface layers 4 may be the same or different in material. That is, (c-1) the two surface layers 4 may be of the same material that is different from the metal material penetrating the active material layer 3 or (b-2) the material of one of the surface layers 4, the material of the other surface layer 4, and the metal material penetrating the active material layer 3 may be different from each other.

It is preferred that the metal material having low capability of forming a lithium compound penetrate the entire thickness of the active material layer 3 and connects to both of the surface layers 4, whereby the two surface layers 4 are electrically connected via the metal material to provide the negative electrode 10 with increased electroconductivity. That is, the whole negative electrode 10 serves a current collecting function. Whether a metal material having low capability of forming a lithium compound penetrates the entire thickness of the active material layer to connect the two surface layers can be confirmed by electron microscope mapping of distribution of the material. A preferred method of penetrating the metal material into the active material layer will be described later.

It is preferred that the metal material having low capability of forming a lithium compound not completely fill the interstices between the active material particles 2 but leave vacant spaces or voids 6 in the active material layer 3. It should be noted that the voids 6 differ from the micropores 5 formed in the surface layer 4. The voids 6 serve to relax the stress caused by expansion and contraction of the active material particles 2 accompanying intercalation/deintercalation of lithium. In this connection, the proportion of the voids 6 in the active material layer 3 is preferably about 5% to 30% by volume, still preferably about 5% to 9% by volume. The proportion of the voids 6 can be determined by electron microscope mapping. When the active material layer 3 is formed by applying an electroconductive slurry containing the active material particles 2, followed by drying as described infra, voids 6 are necessarily formed in the active material layer 3. Accordingly, the volume proportion of the voids 6 can be controlled within the recited range by properly selecting the particle size of the active material particles 2, the composition of the electroconductive slurry, and the conditions for applying the slurry. The volume proportion of the voids 6 may also be adjusted by pressing the dried active material layer 3 under proper conditions.

The active material layer 3 preferably contains a particulate electroconductive carbon or metal material 7 in addition to the particulate active material 2, thereby to add improved electroconductivity to the negative electrode 10. From this viewpoint, the amount of the electroconductive carbon or metal material 7 in the active material layer 3 is preferably 0.1% to 20% by weight, still preferably 1% to 10% by weight. The electroconductive carbon material includes particles of acetylene black and graphite. These electroconductive materials preferably have a particle size of 40 μm or smaller, still preferably 20 μm or smaller, in view of imparting more electroconductivity. The lower limit of the particle size is not critical, which means the smaller, the better. In the light of the process of making the particles, the lower limit would be about 0.01 μm.

A first preferred process of producing the negative electrode of the first embodiment will be described with reference to FIG. 2. First of all, a negative electrode is made. In the making of a negative electrode, a carrier foil 1 is prepared as shown in FIG. 2(a). The carrier foil 11 is not limited in material but is preferably electrically conductive. As long as being electroconductive, the carrier foil 11 does not need to be metal, but when the carrier foil 11 which is metal is used, such an advantage is obtained that a used foil can be melted and recycled into foil after making the negative electrode. From the standpoint of easy recyclability, the material of the carrier foil 11 is preferably the same as the surface layer 4 formed by electroplating hereinafter described. Serving as a support for making the negative electrode 10, the carrier foil 11 preferably has such strength not to wrinkle or twist during fabrication of the negative electrode. From this perspective, the carrier foil 11 preferably has a thickness of about 10 to 50 μm. Since the primary role of the carrier foil 11 is to serve as a support as mentioned, production of the negative electrode 10 does not always require use of the carrier foil when the surface layer 4 is strong enough.

The carrier foil can be prepared by, for example, electrolysis or rolling. Rolling provides a carrier foil with small surface roughness. Such a carrier foil with small surface roughness has a merit that a release layer 11a (hereinafter described) is unnecessary. Where the carrier foil 11 is fabricated by electrolysis, on the other hand, operations from production of the carrier foil 11 to production of the negative electrode 10 can be carried out on the same production line. The in-line production of the carrier foil 11 is advantageous for stable production of the negative electrode and reduction of production cost. Electrolytic foil 11 is obtained by electrolysis in an electrolytic bath containing metal ions (e.g., copper or nickel ions) using a rotary drum as a cathode to deposit the metal on the drum. The deposited metal is peeled from the drum to obtain the carrier foil 11.

When the carrier foil 11 has small surface roughness, the active material layer 3 can be formed directly on the carrier foil 11. Otherwise, the carrier foil may be provided with a release layer 11a as shown in FIG. 2(a), on which the active material layer 3 is formed. The release layer 11a not only facilitates peeling but imparts anticorrosion to the carrier foil 11. Irrespective of whether or not the release layer 11a is formed, the carrier foil 11 preferably has a surface roughness Ra of 0.01 to 3 μm, still preferably 0.01 to 1 μm, even still preferably 0.01 to 0.2 μm. With this small surface roughness, the electrode directly built up on the carrier foil 11 can be peeled off successfully, or, the release layer 11a can be formed thereon with a uniform thickness. Where the release layer 11a is provided, the surface roughness Ra of the carrier foil 11 may in some cases exceed the recited range without causing any problem; for the surface roughness of the carrier foil 11 would be reduced by the release layer 11a.

The release layer 11a is preferably formed by, for example, plating with chromium, nickel or lead or chromating. The reason for this preference is that the resulting release layer 11a forms an oxide or salt skin layer, which has a function to reduce the adhesion between the carrier foil 11 and an electrodeposited layer (hereinafter described) thereby to improve releasability. Organic compounds are also useful as a release agent. Nitrogen-containing compounds or sulfur-containing compounds are particularly preferred. The nitrogen-containing compounds preferably include triazole compounds, such as benzotriazole (BTA), carboxybenzotriazole (CBTA), tolyltriazole (TTA), N′,N′-bis(benzotriazolylmethyl)urea (BTD-U), and 3-amino-1H-1,2,4-triazole (ATA). The sulfur-containing compounds include mercaptobenzothiazole (MBT), thiocyanuric acid (TCA), and 2-benzimidazolethiol (BIT). These organic compounds are used in the form of a solution in an alcohol, water, an acidic solvent, an alkaline solvent, etc. The concentration of the solution of CBTA, for example, is preferably 2 to 5 g/l. The release layer 11a of the organic compound can be formed by applying the solution to the carrier foil 11. A dipping method is also employable. For successful peel, the thickness of the release layer 11a is preferably 0.05 to 3 μm. The release layer 11a formed on the carrier foil 11 preferably has a surface roughness Ra of 0.01 to 3 μm, still preferably 0.01 to 1 μm, even still preferably 0.01 to 0.2 μm, similarly to the carrier foil 11 on which the active material layer 3 is to be formed directly.

The carrier foil 11 prepared by electrolysis has, in the nature of the process, a smooth glossy surface on one side thereof and a rough, matte surface on the other side. In other words, the two sides of the electrolytic foil 11 are different in surface roughness. The glossy surface is the side that has faced the rotary drum and the matte surface is the side on which the metal has deposited. The release layer 11a, if necessary, can be formed on either the glossy surface or the matte surface. Forming the release layer 11a on the glossy surface with smaller surface roughness is preferred for better releasability. Where the release layer 11a is formed on the matte surface, it is recommended to use an electrolytic foil formed in the presence of an electrolyte additive, such as the additive disclosed in JP-A-9-143785, or to etch the matte surface before forming the release layer 11a, or to roll the matte surface, thereby to reduce the surface roughness.

In the next step, an electroconductive slurry containing active material particles is applied to the release layer 11a to form an active material layer 3 as depicted in FIG. 2(b). Where there is not the release layer 11a, the active material layer 3 is directly formed on the carrier foil 11. The slurry contains a particulate active material, a particulate electroconductive carbon or metal material, a binder, a diluting solvent, etc. Useful binders include styrene-butadiene rubber (SBR), polyvinylidene fluoride (PVDF), polyethlene (PE), and an ethylene-propylene-diene monomer (EPDM). Useful diluting solvents include N-methylpyrrolidone and cyclohexane. The slurry preferably contains about 14% to 40% by weight of the particulate active material, about 0.4% to 4% by weight of the particulate electroconductive carbon or metal material, about 0.4% to 4% by weight of the binder, and about 60% to 85% by weight of the diluting solvent.

The active material layer 3 formed on drying the applied slurry has numerous fine interstices between the active material particles. The carrier foil 11 with the active material layer 3 is then immersed in a plating bath containing a metal material having low capability of forming a lithium compound to conduct electroplating (this process will hereinafter be sometimes called penetration plating). On immersing the active material layer 3 in the plating bath, the plating bath penetrates into the interstices and reaches the interface between the active material layer 3 and the release layer 11a. In this state, electroplating is conducted to deposit the metal material having low capability of forming a lithium compound (a) in the inside of the active material layer 3, (b) on the outer surface (the surface in contact with the plating bath) of the active material layer 3, and (c) on the inner surface (the surface in contact with the release layer 11a) of the active material layer 3. As a result, a pair of the surface layers 4 are formed, and the same material as the surface layers 4 penetrates the whole thickness of the active material layer 3 to make the negative electrode 10 shown in FIG. 1 (see FIG. 2(c)).

The conditions of the penetration plating are of importance for depositing the metal material having low capability of forming a lithium compound in the active material layer 3 and for forming a great number of micropores 5 in the surface layers 4. When, for example, a copper sulfate-based solution is used for plating with copper as a metal material with low capability of forming a lithium compound, recommended conditions are 30 to 100 g/l in copper concentration, 50 to 200 g/l in sulfuric acid concentration, 30 ppm or lower in chlorine concentration, 300 to 80° C. in bath temperature, and 1 to 100 A/dm² in current density. In using a copper pyrophosphate-based solution, recommended conditions are 2 to 50 μl in copper concentration, 100 to 700 g/l in potassium pyrophosphate concentration, 30° to 60° C. in bath temperature, 8 to 12 in pH, and 1 to 10 A/dm² in current density. By appropriately adjusting these electrolysis conditions, the metal material having low capability of forming a lithium compound is allowed to penetrate through the whole thickness of the active material layer 3 to form a pair of surface layers 4 that are electrically connected to each other, and the aforementioned numerous micropores 5 are easily formed in the surface layers 4. If the current density is too high, metal deposition takes place only on the outer surface, but not in the inside, of the active material layer 3.

According to the above-described process, two operations are performed simultaneously: the operation for depositing a metal material having low capability of forming a lithium compound inside the active material layer 3 and the operation for forming a surface layer 4 having micropores 5 on at least one side of the active material layer 3. In this process, the metal material deposited inside the active material layer 3 and the material constituting the surface layer 4 on at least one side of the active material layer 3 are the same. It is possible to carry out these two operations separately. In this case, the metal material having low capability of forming a lithium compound is deposited inside the active material layer 3 by penetration plating, and the carrier foil 11 having the active material layer 3 is then immersed in another plating bath to carry out electroplating to form the surface layer 4 on the active material layer 3. By so doing, it is possible to make each surface layer of a material different from the metal material deposited inside the active material layer 3. When the surface layer 4 is formed by electroplating separately from the penetration plating, the conditions of the former can be the same as for the latter, whereby the micropores are successfully formed in the surface layer 4.

The technique of forming the micropores 5 in the surface layer 4 by electroplating does not involve outer force application unlike the hereinafter described method by pressing and is therefore advantageous in that the surface layer 4 is not damaged, which means that the negative electrode 10 is not damaged. The present inventors assume that the micropores 5 are formed during the formation of the surface layer 4 through the following mechanism. Since the active material layer 3 contains the particulate active material 2, it has a microscopically textured surface, that is, a mixed profile having active sites where deposit grows easily and sites where deposit does not grow easily. When the active material layer 3 having such a surface condition is electroplated, growth of the deposit differs from site to site, and grains of the material making up the surface layer 4 grow into a polycrystalline structure. On further growth of crystals, adjacent crystals meet, resulting in formation of voids in the meeting site. The thus formed voids connect to each other to form the micropores 5. The micropores 5 formed by the above-described method have an extremely fine structure.

The micropores 5 can also be formed in the surface layers 4 by pressing the formed electrode 10. In order to obtain sufficient electroconductivity, densification by pressing is preferably such that the total thickness of the active material layer 3 and the surface layers 4 after pressing may be 90% or less, still preferably 80% or less, of that before pressing. Pressing can be carried out with, for example, a roll press. It is preferred that the pressed active material layer 3 still have 5% to 30% by volume of the voids 6 as stated supra. When the active material intercalates lithium and expands volumetrically during charging, the voids 6 serve to relax the stress attributed to the volumetric expansion. Such voids 6 can be obtained by controlling the pressing conditions as described. The void volume of the voids 6 can be determined by electron microscopic mapping as described.

In the subject process of production, it is possible to press the active material layer 3 before the electroplating. For the sake of distinguishing from the above-mentioned pressing, the pressing before the electroplating will be called prepressing. Prepressing is effective in preventing separation between the active material layer 3 and the surface layer 4 and preventing the active material particles 2 from being exposed on the surface of the negative electrode 10. Deterioration of battery cycle life due to fall-off of the active material particles 2 can thus be averted. Moreover, prepressing is effective in controlling the degree of penetration of the material constituting the surface layer 4 into the active material 3. Specifically, a high degree of pressing results in reduction of the distance between active material particles 2, which makes the active material 3 less permeable to the material constituting the surface layer 4. Conversely, when the degree of pressing is small, the distance between the active material particles 2 remains long and ready to allow the material making up the surface layer 4 to penetrate into the active material 3. The prepressing conditions are preferably such that the thickness of the active material layer 3 after prepressing is 95% or less, still preferably 90% or less, of that before prepressing.

The negative electrode 10 is then separated from the carrier foil 11 at the release layer 11a as shown in FIG. 2(d). While FIG. 2(d) shows that the release layer 11a is left on the side of the carrier foil 11, the release layer 11a is, in fact, left sometimes on the side of the carrier foil 11, sometimes on the side of the negative electrode 10, and sometimes on both. In any case, the presence of the release layer 11a, being extremely thin, gives no adverse influences on the performance of the resulting negative electrode 10.

Finally, an output terminal is attached to either of the surface layers 4 by a prescribed means. As previously stated, methods of attachment include ultrasonic welding, laser welding, and solder welding. The production process of the present invention does not require positioning the output terminal in an active material-deficient part, as has been needed in attaching an output terminal in the conventional manufacture of electrodes. Therefore, the process of the invention is a simplified process.

A second and a third preferred process of producing the negative electrode of the present embodiment will then be described only with reference to the points different from the first process. The description about the first process appropriately applies to those particulars of the second and third processes that are not explained here.

In the second process, one surface of a carrier foil, with or without a release layer formed thereon, is electroplated to form a first surface layer. An electroconductive slurry containing a particular active material is applied to the first surface layer to form an active material layer. The active material layer is electroplated to form a second surface layer. The carrier foil is peeled off the first surface layer to obtain a negative electrode. Thereafter, the same procedure as in the first process is followed, and two negative electrodes are joined together.

The second process is different from the first one in that formation of an active material layer is preceded by formation of one of the surface layers (a first surface layer) on one side of the carrier foil. The subsequent operations are virtually the same as in the first process. The electroplating conditions for the formation of the first surface layer can be the same as those used in the first process, whereby micropores are successfully formed in the first surface layer.

In the third process, the formation of the first surface layer on one surface of a carrier foil in the second process is preceded by formation of a thin coat of a material different from the material making the first surface layer. The first surface layer is then deposited thereon by electroplating. The above operation makes it easier to control the number and open area of the micropores to be formed in the first surface layer.

The coat serves to make the carrier foil surface, on which the surface layer is to be formed, non-uniform in electroconductivity thereby to form a large number of micropores in the resulting surface layer. The coat is preferably applied to a thickness of 0.001 to 1 μm, still preferably 0.002 to 0.5 μm, even more preferably 0.005 to 0.2 μm. Applied to a thickness in that range, the coat covers the surface of the carrier foil discontinuously, for example in the form of islands.

The coat is made of a material different from the material making up the surface layer, whereby the surface layer can successfully be peeled from the carrier foil in the step of peeling. It is preferred that the material of the coat, which is different from the material making the surface layer, contain at least one element of Cu, Ni, Co, Mn, Fe, Cr, Sn, Zn, In, Ag, Au, C, Al, Si, Ti, and Pd.

The process of forming the coat is not particularly restricted. For example, the process of forming the coat is selected in relation to the process of forming the surface layer. More specifically, where the surface layer is to be formed by electroplating, it is preferred to form the coat also by electroplating from the standpoint of production efficiency and the like. The coat may also be formed by other processes, such as electroless plating, sputtering, physical vapor deposition (PVD), chemical vapor deposition (CVD), a sol-gel process, and ion plating.

Where the coat is formed by electroplating, a proper plating bath and plating conditions are decided according to the constituent material of the coat. For instance, in making the coat of tin, a plating bath having the composition shown below or a tin borofluoride bath can be used. In using these plating baths, the bath temperature is preferably about 15° to 30° C., and the current density is preferably about 0.5 to 10 A/dm².

| | |
|---|---|
| SnSO₄ | 30 to 70 g/l |
| H₂SO₄ | 60 to 150 g/l |
| Cresolsulfonic acid | 70 to 100 g/l |

As stated above, the coat is used to provide the surface, on which a surface layer is to be formed, with non-uniform electroconductivity. When the material making the coat is largely different from the carrier foil in electroconductivity, application of the coat immediately imparts non-uniformity of electroconductivity to the surface on which a surface layer is to be formed. Use of carbon as a material of the coat is an example of that case. On the other hand, when the coat is formed of a material whose electroconductivity is about the same as that of the carrier foil, such as various metallic materials including tin, application of the coat does not immediately result in non-uniform electroconductivity of the surface for forming a surface layer. Then, in case where the coat is made of such a material, it is preferred that the carrier foil having the coat formed thereon be exposed to an oxygen-containing atmosphere, such as the air, in a dried state, thereby to oxidize the surface of the coat (and the exposed area of the carrier foil). By this operation, the surface of the carrier foil on which to form a surface layer takes on nonuniform electroconductivity. When electroplating (described infra) is performed on the surface with the thus created nonuniformity of electroconductivity, there is produced a difference in electrodeposition rate between the surface of the coat and the exposed area of the carrier foil. As a result, a surface layer having micropores can easily be formed. The degree of oxidation is not critical in the present invention. According to the present inventors' study, it has been confirmed that allowing the carrier foil having the coat formed thereon in the atmosphere for about 10 to 30 minutes is sufficient. The carrier foil having the coat formed thereon cannot be protected from being forcibly oxidized, nevertheless.

The reason why the exposure of the carrier foil having the coat formed thereon to an oxygen-containing atmosphere is carried out in a dried state is for the sake of oxidation efficiency. Where the coat is formed by electroplating, for example, the carrier foil taken out of the plating bath is dried by means of a dryer, etc. and allowed to stand in the atmosphere for a predetermined time. Where the coat is formed by dry processes, such as sputtering and various vacuum deposition techniques, the drying operation is unnecessary, and the foil having the coat deposited thereon is left to stand in the atmosphere as it is.

Oxidizing the coat may be followed by applying a release agent. A surface layer-forming material is deposited by electroplating on the coat, with or without the release agent applied thereon, to form a surface layer. The resulting surface layer contains a great number of micropores attributed to the coat. The plating bath and plating conditions are chosen as appropriate to the material of the surface layer. In making a surface layer of Ni, for instance, a Watts bath having the composition shown below or a sulfamic acid bath can be used as a plating bath. In using these baths, the bath temperature is preferably about 40° to 70° C., and the current density is preferably about 0.5 to 20 A/dm².

| | |
|---|---|
| NiSO₄•6H₂O | 150 to 300 g/l |
| NiCl₂•6H₂O | 30 to 60 g/l |
| H₃BO₃ | 30 to 40 g/l |

After forming the surface layer on the carrier foil, the same procedures as in the second process are followed to obtain a negative electrode.

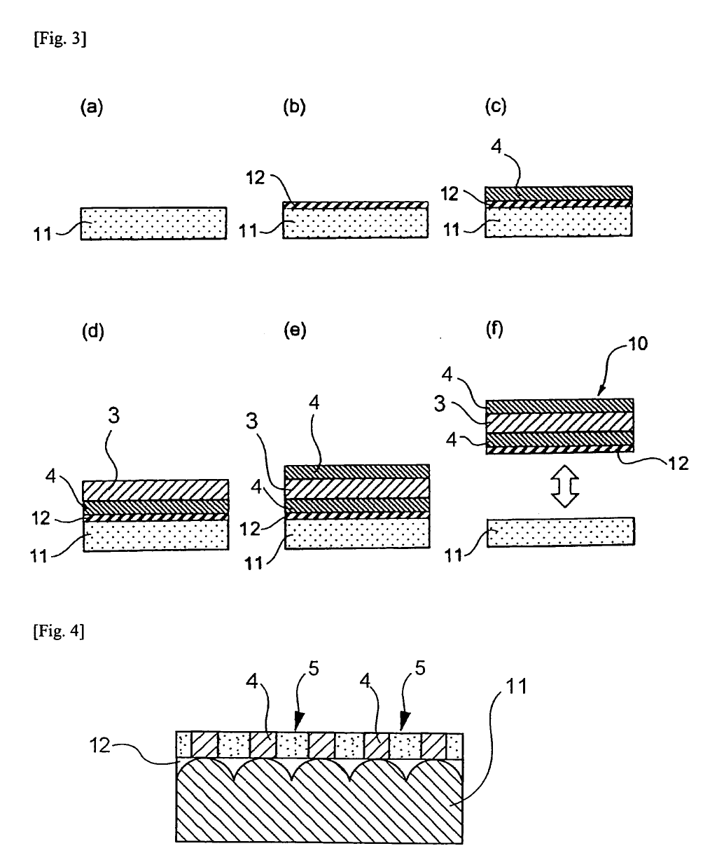

Another preferred process of producing the negative electrode 10 of the present embodiment is described with reference to FIG. 3. The description already given of the first to third processes appropriately applies to the points of this process that are not explained here. The present process includes the steps of first forming a lower surface layer 4, forming an active material layer 3 on the lower surface layer 4, and forming an upper surface layer 4 on the active material layer 3. The process starts with preparation of a carrier foil 11 as shown in FIG. 3(a).

It is preferred for the carrier foil 11 to have some roughness on its surface. Rolled foil has a smooth surface on both sides thereof in the nature of the process, whereas electrolytic foil has a rough surface on one side and a smooth surface on the other side. The rough surface is the metal-deposited side in the electroplating process. So, the rough surface of an electrolytic foil can be made use of as the surface on which the lower surface layer 4 is to be electrodeposited, which is more convenient than using a carrier foil with its surface rendered rough by any surface treatment. The advantages attributed to the use of a rough surface will be described later. The rough surface, when used as a substrate to be electroplated, preferably has a surface roughness Ra (JIS B0601) of 0.05 to 5 μm, still preferably 0.2 to 0.8 μm, in order to facilitate forming micropores of a desired size and density.

One surface, preferably the rough surface, of the carrier foil 11 is made releasable by applying a release agent. The purpose of applying a release agent is just to facilitate peeling the formed negative electrode 10 off the carrier foil 11 in the hereinafter described step of peeling (see FIG. 3(f)). Therefore, micropores can successfully be formed in the lower surface layer 4 even if the step of applying a release agent is omitted.

After a release agent is applied (not shown), a coating solution containing an electroconductive polymer is applied and dried to form a polymer film 12. Because the coating solution is applied to the rough surface of the carrier foil 11, it is liable to pool in the depressions of the rough surface. Therefore, evaporation of the solvent results in formation of a polymer film 12 with a nonuniform thickness. That is, the polymer film 12 is thicker on the depressions and thinner on the projections of the rough surface of the carrier foil 11. In the present process, the nonuniformity in thickness of the polymer film 12 is taken advantage of to form a large number of micropores in the lower surface layer 4.

Conventionally known electroconductive polymers can be used in the present process with no particular restriction. Examples are polyvinylidene fluoride (PVDF), polyethylene oxide (PEO), polyacrylonitrile (PAN), and polymethyl methacrylate (PMMA). Lithium ion conducting polymers are also preferred. The electroconductive polymers are preferably fluorine-containing ones; for fluorine-containing polymers are stable against heat and chemicals and mechanically strong. From all these considerations, polyvinylidene fluoride, which is a fluorine-containing polymer having lithium ion conductivity, is the most preferred.

The coating solution of the electroconductive polymer is a solution of the electroconductive polymer dissolved in a volatile organic solvent. For example, N-methylpyrrolidone is used as an organic solvent for polyvinylidene fluoride.

It is believed that a large number of micropores are formed in the lower surface layer 4 by the following mechanism. The carrier foil 11 coated with the polymer film 12 is electroplated to form the lower surface layer 4 as shown in FIG. 3(c). FIG. 4 schematically represents an enlargement of FIG. 3(c). The electroconductive polymer making the polymer film 12 is electron-conductive anyhow, while not so conductive as metal. The electroconductivity of the polymer film 12 varies with the film thickness. Therefore, metal being deposited on the polymer film 12 shows variations in deposition rate in accordance with the variations in polymer film thickness. The variations in deposition rate result in formation of micropores 5 in the lower surface layer 4. The sites of the lower surface layer 4 that correspond to the thicker parts of the polymer film 12, where the deposition rate is low, tend to become micropores 5.

The diameter and density of the micropores 5 are controllable by not only the surface roughness Ra of the carrier foil 11 as mentioned above but also the concentration of the electroconductive polymer in the coating solution. For instance, a lower electroconductive polymer concentration tends to result in a smaller micropore diameter and density. Conversely, a higher electroconductive polymer concentration tends to result in a larger diameter. From this point of view, a preferred electroconductive polymer concentration in the coating solution is 0.05% to 5% by weight, still preferably 1 to 3% by weight. The coating solution can be applied to the carrier foil 11 either by any coating technique including dipping.

The plating bath composition and other plating conditions for forming the lower surface layer 4 are decided appropriately according to the material of the surface layer 4. Plating baths for making the surface layer 4 of copper include a copper sulfate bath having the composition below and a copper pyrophosphate bath. In using these plating baths, a preferred bath temperature is about 40° to 70° C., and a preferred current density is about 0.5 to 50 A/dm².

CuSO₄.5H₂O: 150 to 350 g/l

H₂SO₄: 50 to 250 g/l

The surface layer 4 having a large number of micropores 5 is coated with an electroconductive slurry containing a particulate active material to form an active material layer 3. The active material layer 3 thus formed has a numerous fine interstices between the particles. The carrier foil 11 with the active material layer 3 is immersed in a plating bath containing a metal material, a kind of electroconductive materials, to conduct electroplating (penetration plating). On immersing the active material layer 3 in the plating bath, the plating bath penetrates into the interstices and reaches the interface between the active material layer 3 and the lower surface layer 4. In this state, electroplating is performed to deposit the metal material (a) in the inside of the active material layer 3 and (b) on the inner surface (the surface in contact with the lower surface layer 4) of the active material layer 3. Thus, the metal material penetrates through the whole thickness of the active material layer 3.

The upper surface layer 4 is then formed on the active material layer 3. Containing active material particles, the active material layer 3 has a rough surface. Therefore, the upper surface layer 4 can be formed while creating a large number of micropores 5 in itself by adopting the same technique as in forming the lower surface layer 4 on the rough side of the electrolytically prepared carrier foil 11. That is, a coating solution containing an electroconductive polymer is applied to the active material layer 3 followed by drying to form a polymer film (not shown). The polymer film (not shown) is then electroplated under the same conditions as in the formation of the lower surface layer 4 to form the upper surface layer 4 as shown in FIG. 3(e).

The carrier foil 11 is peeled off the lower surface layer 4 to give a negative electrode 10 as shown in FIG. 3(f). Although FIG. 3(f) shows that the polymer film 12 remains on the side of the lower surface layer 4, whether the polymer film 12 actually remains on the side of the carrier foil 11 or the lower surface layer 4 or both of them depends on the thickness or the material of the polymer film 12. Finally, an output terminal is attached to the surface of either one of the surface layers 4.

The thus obtained negative electrode 10 according to the present embodiment is assembled into a nonaqueous electrolyte secondary battery together with a known positive electrode, separator, and nonaqueous electrolyte. A positive electrode is produced by applying a positive electrode active material mixture to a current collector, drying, rolling, pressing, and cutting or punching. The positive electrode active material mixture is prepared by suspending a positive electrode active material and, if needed, an electroconductive material and a binder in an appropriate solvent. The positive electrode active material includes conventionally known ones, such as lithium-nickel complex oxide, lithium-manganese complex oxide, and lithium-cobalt complex oxide. Preferred separators include nonwoven fabric of synthetic resins and a porous film of polyethylene or polypropylene. The nonaqueous electrolyte used in a lithium secondary battery, for instance, is a solution of a lithium salt, a supporting electrolyte, in an organic solvent. The lithium salt includes LiBF₄, LiClO₄, LiAlCl₄, LiPF₆, LiAsF₆, LiSbF₆, LiSCN, LiCl, LiBr, LiI, LiCF₃SO₃, and LiC₄F₉SO₃.

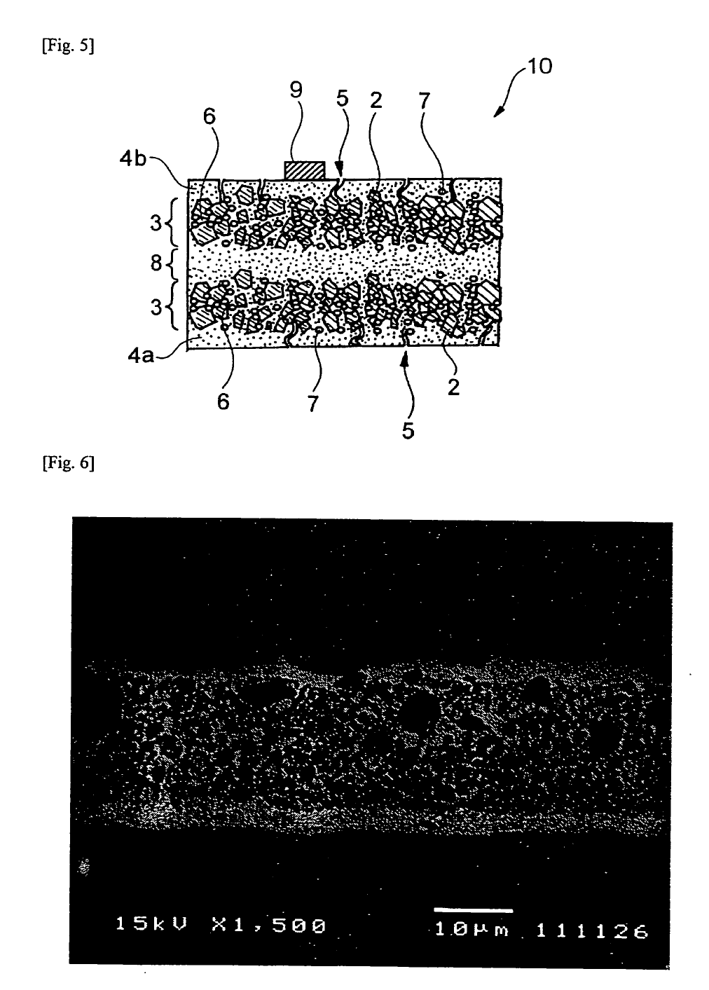

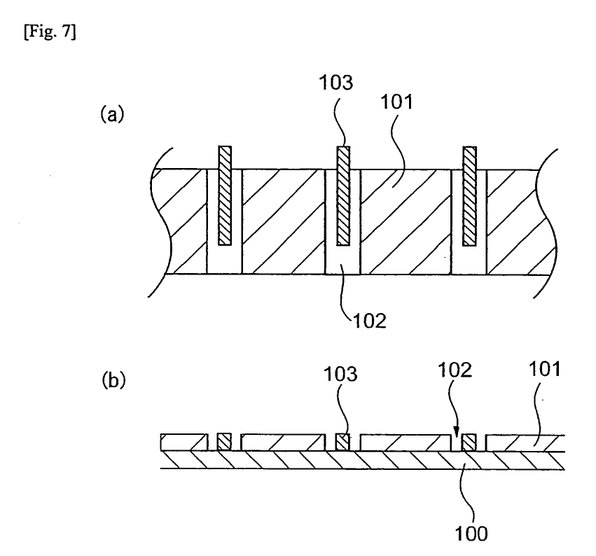

The second embodiment of the electrode according to the present invention will then be described by referring to FIG. 5. The second embodiment will be described only with reference to the differences from the first embodiment. The detailed description of the first embodiment applies appropriately to the points of the second one that are not referred to here. The members in FIG. 5 which are the same as in FIG. 1 are given the same reference numerals as used in FIG. 1.

As shown in FIG. 5, the negative electrode of the second embodiment has an electroconductive metal foil layer 8 as a core in the middle of its thickness. An active material layer 3 is formed on each side of the metal foil layer 8, and the active material layers 3 are covered with the respective current collecting surface layers 4a and 4b. The metal foil layer 8 is made of, for example, the same material as used to make the current collecting surface layers. To ensure strength, a high-strength rolled copper alloy foil or a stainless steel foil can be used.

The active material layer 3 has a metal material having low capability of forming a lithium compound penetrating into the interstices between the active material particles 2. It is preferred that the metal material penetrates throughout the thickness of each active material layer 3. The active material particles 2 are not exposed on the surface of the electrode and embedded inside the surface layers 4a and 4b. The metal material having low capability of forming a lithium compound penetrates the whole thickness of the active material layers 3 and reach the metal foil layer 8. Therefore, the surface layers 4a and 4b electrically connect to the metal foil layer 8 to increase the electroconductivity of the negative electrode as a whole. Similarly to the negative electrode of the first embodiment, the negative electrode of the present embodiment performs a current collecting function as a whole.

The negative electrode 10 has an output terminal 9 attached to the surface of the surface layer 4b. Similarly to the first embodiment, the position of attaching the output terminal 9 is at the position corresponding to the position, in viewing along the thickness direction of the negative electrode 10, where the active material layer 3 exists. With the output terminal 9 so attached, the negative electrode of the present embodiment produces the same effects as with the negative electrode of the first embodiment.

The surface layers 4a and 4b and active material layers 3 in the present embodiment can be designed to have the same thicknesses as in the first embodiment. For securing increased energy density by minimizing the total thickness of the negative electrode, the thickness of the metal foil layer 8 is preferably 5 to 40 μm, still preferably 10 to 20 μm. From the same viewpoint, the total thickness of the negative electrode is preferably 10 to 100 μm, still preferably 20 to 60 μm.

A process for producing the negative electrode according to the present embodiment is briefly described below. An electroconductive slurry containing a particulate active material is applied to both sides of a metal foil layer 8 to form active material layers. The metal foil layer 8 may be previously produced or be produced in an in-line step of the production of the negative electrode. Where the metal foil layer 8 is in-line produced, it is preferably produced by electrolytic deposition. After the applied slurry dries to form active material layers, the metal foil layer 8 having the active material layers thereon is immersed in a plating bath containing a metal material having low capability of forming a lithium compound and electroplated in this state with the metal material to form the surface layers 4a and 4b. By this process a large number of micropores can easily be formed in the surface layers 4a and 4b, and the metal material making the surface layers 4a and 4b penetrates the whole thickness of the active material layers to provide an electrical connection between both the surface layers and the metal foil layer 8.

In another process, the metal foil layer 8 having the active material layers formed thereon is immersed in a plating bath containing a metal material having low capability of forming a lithium compound. Electroplating is performed in this state to deposit the metal material in the active material layers. The metal foil layer 8 having the active material layers formed thereon is then immersed in a plating bath containing a metal material that has low capability of forming a lithium compound and is different from the first mentioned metal material to carry out electroplating. A surface layer having a large number of micropores is thus formed on each of the active material layers.

The present invention is not limited to the aforementioned embodiments. For example, as a modification of the negative electrode of the embodiment illustrated in FIG. 5, a negative electrode may be composed of a pair of the negative electrodes of the embodiment illustrated in FIG. 1, the two negative electrodes united with their surface layers 4 facing each other. Otherwise, an electroconductive metal foil may be interposed between the pair of the negative electrodes, and the three members are joined into a unitary negative electrode. The latter structure has an enhanced strength as a negative electrode, which offers an advantage that, where a negative electrode needs to be bent in battery assembly, the electrode strength is guaranteed against bending stress. Electroconductive metal foils of various materials having low capability of forming a lithium compound can be used in that structure, including electrolytic copper foil, rolled copper alloy foil, and stainless steel foil. Taking the balance between the effect of improving strength and the energy density into consideration, the thickness of the metal foil preferably ranges from about 5 to 35 μm, still preferably from 12 to 18 μm. A porous metal foil, such as punching metal, or a foil of the above-described material having a lithium layer formed thereon is also usable as an electroconductive metal foil.

While in the aforementioned embodiments, the metal material with low capability of forming a lithium compound penetrates the entire thickness of the active material layer to electrically connect the two surface layers, the surface layers do not always need to have an electrical connection as long as the current collecting capabilities of each surface layer 4 can be secured sufficiently. In order to increase the active sites for the electrode reaction between the active material particles and the electrolyte, a hole that is open on at least one surface layer and reaches at least part of the active material layer or a through-hole piercing the whole thickness of the negative electrode may be formed by laser machining or with a punch, a needle, etc.

While in the above embodiments each of the surface layers 4 has a single layer structure, at least one of them may have a multilayer structure having two or more sublayers made of different materials. For example, the surface layer 4 may have a double layer structure composed of a nickel lower sublayer and a copper upper sublayer. Such a double layer structure is more effective in preventing noticeable deformation of the negative electrode ascribed to the volume change of the active material. Where the surface layer 4 has a multilayer structure, at least one of the materials making up the sublayers may be different from the metal material penetrating the active material layer 3. All the materials making up the respective sublayers may be different from the metal material.

When the material of the surface layer 4 is different from the metal material penetrating the active material layer 3, the metal material penetrating the active material layer 3 may be present up to the boarder between the active material layer 3 and the surface layer 4, or the metal material may exceed that boarder and constitute part of the surface layer 4. Conversely, the material constituting the surface layer 4 may exceed that boarder and be present in the active material layer 3.

It is possible to carry out depositing the material that has low capability of forming a lithium compound in the active material layer 4 in two or more divided steps of penetration plating using as many different metal materials. In this case, the active material layer 4 has two or more metal materials deposited therein in as many layers.

While the above embodiments have been described with particular reference to a negative electrode for nonaqueous electrolyte secondary batteries, the present invention is also applicable to a positive electrode for the same type of batteries.

### EXAMPLES

### Example 1

An electrode was made in accordance with the process depicted in FIG. 3. A 35 μm thick electrolytic copper foil as a carrier foil was cleaned with an acid cleaning solution at room temperature for 30 seconds and then with pure water at room temperature for 30 seconds. The carrier foil was immersed in a 3.5 g/l CBTA solution maintained at 40° C. for 30 seconds to accomplish a release treatment. After the release treatment, the carrier foil was taken out of the solution and washed with pure water for 15 seconds.

A 2.5 wt % solution of polyvinylidene fluoride in N-methylpyrrolidone was applied to the rough side of the carrier foil (Ra=0.5 μm). The solvent vaporized to form a polymer film. The carrier foil coated with the polymer film was immersed in an H₂SO₄/CuSO₄-based plating bath containing 250 g/l of CuSO₄ and 70 g/l of H₂SO₄ and electroplated at a current density of 5 A/dm² to form a surface layer of copper on the polymer film to a deposit thickness of 5 μm. The carrier foil was taken out of the plating bath and washed with pure water for 30 seconds and dried in the atmosphere.

A slurry containing a particulate active material was applied to the surface layer to a thickness of 18 μm to form an active material layer. The particulate active material was Si particles having a median diameter D₅₀ of 2 μm. The slurry contained the active material, acetylene black, and styrene-butadiene rubber at a ratio of 93:2:5.

The carrier foil having the active material layer formed thereon was immersed in a Watt's bath having the following composition, and the active material layer was penetration-plated with nickel by electrolysis under conditions of a current density of 5 A/dm², a bath temperature of 50° C., and a bath pH of 5. A nickel electrode was used as an anode, and a direct current power source was used. The penetration plating was stopped when part of the active material particles were still exposed on the plated surface. The carrier foil taken out of the plating bath was washed with pure water for 30 seconds and dried in the atmosphere.

NiSO₄.6H₂O: 250 g/l

NiCl₂.6H₂O: 45 g/l

H₃BO₃: 30 g/l

A 2.5 wt % solution of polyvinylidene fluoride in N-methylpyrrolidone was applied to the active material layer. The solvent vaporized to form a polymer film. The carrier foil coated with the polymer film was immersed in an Cu plating bath containing 200 g/l of H₃PO₄ and 200 g/l of Cu₃(PO₄)₂.3H₂O to carry out electroplating at a bath temperature of 40° C. at a current density of 5 A/dm² to form a surface layer of copper on the polymer film to a deposit thickness of 2 to 3 μm. The carrier foil was taken out of the plating bath and washed with pure water for 30 seconds and dried in the atmosphere.

The carrier foil was stripped off the lower surface layer to give a negative electrode for nonaqueous electrolyte secondary batteries having the active material layer sandwiched in between a pair of surface layers. An electron micrograph of a cut area of the resulting negative electrode is shown in FIG. 6. As a result of electron microscopic observation of the surface layers, it was confirmed that the upper and the lower surface layers had 50 and 30 micropores, respectively, in average per 1 cm square. Finally, an output terminal made of nickel was attached to the surface of the upper surface layer by ultrasonic welding.

### Example 2

A negative electrode was made in the same manner as in Example 1, except that the lower and the upper surface layers were formed as follows.

An 8 μm thick first surface sublayer of copper having micropores was formed by electroplating using the same plating bath composition and plating conditions as used in the formation of the lower surface layer in Example 1. A 2 μm thick second surface sublayer of nickel having micropores was formed on the first surface sublayer using a Watt's bath having the following composition at a bath temperature of 50° C. and a bath pH of 5 at a current density of 5 A/dm². There was thus formed a lower surface layer having a double layer structure composed of an 8 μm thick first surface sublayer of copper and a 2 μm thick second surface sublayer of nickel.

A 2 μm thick second surface sublayer of nickel having micropores was formed on the active material layer by electroplating. An 8 μm thick first surface sublayer of copper having micropores was formed thereon by electroplating. The plating bath compositions and plating conditions used to form the first and second surface sublayers were the same as those used to form the lower surface layer. There was thus formed an upper surface layer having a double layer structure composed of a 2 μm thick second surface sublayer of nickel that was adjacent to the active material layer and an 8 μm thick first surface sublayer of copper that was adjacent to the second surface sublayer.

### Performance Evaluation:

Nonaqueous electrolyte secondary batteries were produced as follows using each of the negative electrodes obtained in Examples 1 and 2. The resulting batteries were evaluated by measuring the maximum discharge capacity, the battery capacity, and the capacity retention at the 50th cycle in accordance with the following methods. The results of measurements are shown in Table 1.

### Assembly of Nonaqueous Electrolyte Secondary Battery:

The negative electrode obtained in Examples 1 and 2 and Comparative Example 2 as a working electrode and LiCoO₂ as a counter electrode were placed to face each other with a separator between them and assembled into a nonaqueous electrode secondary battery in a usual manner using an LiPF₆ solution in a 1:1 by volume mixed solvent of ethylene carbonate and dimethyl carbonate as a nonaqueous electrolyte.

### 1) Maximum Discharge Capacity

The discharge capacity per weight of the active material (mAh/g) at the cycle at which a maximum discharge capacity was reached was measured.

### 2) Capacity Retention at the 50th Cycle

The discharge capacity at the 50th cycle was divided by the maximum discharge capacity, and the quotient was multiplied by 100 to give percentage retention.

TABLE 1

| | Maximum Discharge | Capacity Retention |
|---|---|---|
| | Capacity (mAh/g) | at 50th Cycle (%) |
| Example 1 | 3000 | 90 |
| Example 2 | 2900 | 90 |

As is apparent from the results in Table 1, the batteries having the negative electrodes of Examples 1 and 2 exhibit high performance in both maximum discharge capacity and capacity retention at the 50th cycle.

### INDUSTRIAL APPLICABILITY

The electrode for nonaqueous electrolyte secondary batteries of the present invention has a place in itself to attach an output terminal. It is no more necessary to provide an active material-deficient region that has been required for the attachment of an output terminal. As a result, the electrode has an accordingly increased capacity. No need to provide an active material-deficient region brings about simplification of the production process. The output terminal can be directly attached to the surface of the electrode with no particular positional restriction, which also makes the production process simpler.

1. An electrode for nonaqueous electrolyte secondary batteries characterized by having an output terminal attached to a surface of the electrode at a position corresponding to a position, in viewing along the thickness direction of the electrode, where an active material layer exists.

2. The electrode for nonaqueous electrolyte secondary batteries according to claim 1, wherein an active material contained the active material layer comprises a material having low electroconductivity.

3. The electrode for nonaqueous electrolyte secondary batteries according to claim 1, comprising a pair of current collecting surface layers and at least one active material layer interposed between the surface layers, the surface of each of the surface layers being adapted to be brought into contact with an electrolyte, the active material layer containing a particulate active material having high capability of forming a lithium compound, wherein the output terminal is attached to the surface of the current collecting surface layer.

4. The electrode for nonaqueous electrolyte secondary batteries according to claim 3, wherein the active material layer has a metal material having low capability of forming a lithium compound and penetrating the interstices between the particles of the active material to provide an electrical connection between the two surfaces of the electrode such that the electrode has a current collecting function as a whole.

5. The electrode for nonaqueous electrolyte secondary batteries according to claim 3, wherein the surface layers each have a thickness of 0.3 to 10 μm.

6. The electrode for nonaqueous electrolyte secondary batteries according to claim 3, wherein at least one of the surface layers has micropores extending in the thickness direction thereof, the micropores being configured to allow a nonaqueous electrolyte to penetrate therethrough.

7. The electrode for nonaqueous electrolyte secondary batteries according to claim 6, wherein the micropores lead to the active material layer, the micropores of at least one of the surface layers have an average open area of 0.1 to 50 μm² and an open area ratio of 0.1% to 20%, and a thick conductor for current collection is absent from the electrode.

8. The electrode for nonaqueous electrolyte secondary batteries according to claim 3, wherein the surface layers are formed by electroplating.

9. The electrode for nonaqueous electrolyte secondary batteries according to claim 3, wherein each of the surface layers contains a metal material having low capability of forming a lithium compound.

10. The electrode for nonaqueous electrolyte secondary batteries according to claim 9, wherein the metal material having low capability of forming a lithium compound contained in the surface layer is different from a metal material having low capability of forming a lithium compound penetrating in the active material layer.

11. The electrode for nonaqueous electrolyte secondary batteries according to claim 9, wherein the metal material having low capability of forming a lithium compound contained in the surface layer is the same as a metal material having low capability of forming a lithium compound penetrating in the active material layer.

12. The electrode for nonaqueous electrolyte secondary batteries according to claim 9, wherein at least one of the surface layers has a multilayer structure having two or more sublayers, and at least one of materials making up the respective sublayers is different from a metal material having low capability of forming a lithium compound penetrating in the active material layer.

13. The electrode for nonaqueous electrolyte secondary batteries according to claim 3, wherein the particulate active material comprises particles of a silicon material or particles of a tin material.

14. The electrode for nonaqueous electrolyte secondary batteries according to claim 3, wherein the electrode further comprises an electroconductive metal foil in the middle of the thickness direction thereof as a core, the active material layer is present on both sides of the metal foil, the current collecting surface layers are each adjacent to the respective active material layers, and the total thickness of the electrode is 10 to 100 μm.

15. The electrode for nonaqueous electrolyte secondary batteries according to claim 1, which is a negative electrode.

16. A process of producing the electrode for nonaqueous electrolyte secondary batteries according to claim 3, the process comprising the steps of:
applying an electroconductive slurry containing a particulate active material to a carrier foil to form an active material layer,
immersing the carrier foil with the active material layer in a plating bath to conduct electroplating to form a surface layer on both sides of the active material layer,
peeling the carrier foil off one of the surface layers to obtain an electrode, and
attaching an output terminal to one of the surface layers.

17. A process of producing the electrode for nonaqueous electrolyte secondary batteries according to claim 3, the process comprising the steps of:
electroplating one side of a carrier foil to form a first current collecting surface layer,
applying an electroconductive slurry containing a particulate active material to the first surface layer to form an active material layer on the active material layer,
electroplating the active material layer to form a second current collecting surface layer on the active material layer,
peeling the carrier foil off the first current collecting surface layer to obtain an electrode, and
attaching an output terminal to one of the current collecting surface layers.

18. The process according to claim 17, further comprising forming a coat of a material different from the material constituting the first current collecting surface layer on the one surface of the carrier foil to a thickness of 0.001 to 1 μm before forming the first current collecting surface layer.
